(19) United States
(12) Patent Application Publication
(10) Pub. No.: US 2005/0276332 A1
(43) Pub. Date: Dec. 15, 2005

(54) Method of communicating data within a coder

(76) Inventors: Erik Boudewijn Van Der Tol, EINDHOVEN (NL); Gerben Johan Hekstra, Eindhoven (NL); Evert-Jan Daniel Pol, Eindhoven (NL); Josephus Theodorus Johannes Van Eijndhoven, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/523,387

(22) PCT Filed: Jun. 16, 2003
(86) PCT No.: PCT/IB03/03254

§ 371 Date: Feb. 1, 2005

(30) Foreign Application Priority Data
Aug. 6, 2002 (EP) 02078241.3

(51) Int. Cl. H04N 7/12

(52) U.S. Cl. 375/240.18; 375/240.24; 375/240.25; 375/240.2

(57) ABSTRACT

Transform based coders are frequently used in digital signal processing. The present invention relates to a method of communicating at least one block of data from a first functional element (3; 4; 7; 12; 14) within a transform based coder (1) or decoder (10) to a second functional element (4; 5; 7; 8; 14; 15) within the coder or decoder, where the block of data comprises a row-column structure of data coefficients. A significant communication workload occurs between individual elements of the coders and decoders. The present invention seeks to reduce this work-load by making an effort to communicate only non-zero coefficients within a cartesian bounding box of a block between various functional units in a decoding or encoding scheme by reducing the size of the at least one block of data to produce a reduced size data block by elimination (31) of one or more rows and/or columns of substantially zero valued coefficients, and communicating (32) the reduced size data block from the first functional element to the second functional element.

### FIELD OF THE INVENTION

The present invention relates to transform based methods for encoding and/or decoding of data. In particular, the invention relates to the communication of data blocks between different functional elements within an encoder or a decoder.

### BACKGROUND TO THE INVENTION

Transform based methods of coding are frequently used in digital signal processing. A typical application is in video compression techniques and devices, for example the ISO Motion Picture Experts Group (MPEG) and International Telecommunication Union (ITU) H26 Standards. Typical devices which may use these video compression techniques include digital video recording devices and playback devices, for example camcorders.

Transform based coders comprise a plurality of different functional elements, including for example; transform elements, quantising elements, scanning elements, inverse quantising elements, inverse scanning elements and inverse transform elements. These elements may be implemented in either hardware or software. A problem with existing coders and associated decoders is the significant amount of internal communication required between the different functional elements within coders and decoders. This communication requirement has an associated processing and power usage requirement.

Accordingly, it is an object of the invention to provide an improved method of coding and/or decoding which has a reduced communication requirement.

### SUMMARY OF THE INVENTION

Accordingly, a first embodiment of the invention provides a method for communicating at least one block of data from a first functional element within a transform based coder or decoder to a second functional element within the coder or decoder, wherein the at least one block of data comprises a row-column structure of data coefficients, characterized in that the method comprises the steps of: reducing the size of the at least one block of data to produce a reduced size data block by elimination of one or more rows and/or columns of redundant data coefficients, and communicating the reduced size data block from the first functional element to the second functional element.

The basic idea behind the invention is that an effort is made to communicate only non-zero coefficients within a Cartesian bounding box of a block between various functional units in a decoding or encoding scheme. By reducing the size of the data blocks communicated, bandwidth becomes available for performing other tasks in a hardware implementation. Additionally, the reduced data blocks ensures a lower processing requirement for communication of the data blocks and the subsequent processing of the data blocks in subsequent elements of the coder. By reducing the communication and computation workload, a consequential reduction in power requirements may be achieved in either a hardware or software implementation. This is particularly advantageous for portable devices, e.g. video cameras, where battery life is of significant importance.

In one variation of the invention, the step of reducing the size of the at least one block of data may comprise the steps of identifying rows and/or columns having only substantially zero valued coefficients as redundant data. The dimensions of the reduced size data block may be communicated to the second functional element.

In an alternative variation of the invention, the step of reducing the size of the at least one block of data may be achieved by the elimination of coefficients outside a predetermined boundary.

The invention further provides a transform based coder, or decoder element adapted to communicate at least one block of data, comprising a row-column structure of data coefficients, to a second functional element of the coder or decoder, comprising means for reducing the size of the at least one block of data to produce a reduced size data block by elimination of one or more rows and/or columns of substantially zero valued coefficients, and means for communicating the reduced size data block to the second functional element.

The means for reducing the size of the at least one block of data may be implemented by selection of coefficients within a predetermined boundary. Alternatively, the means for reducing the size of the at least one block of data may be adapted to identify rows and/or columns having only substantially zero valued coefficients as redundant data. The coder or decoder element may be adapted to communicate the dimensions of the reduced size data block to the second element.

The invention also extends to a digital video recording system comprising an input device for acquiring a video image, the above described transform based coder for coding the acquired video image, and an output device for outputting the acquired coded image.

The invention further extends to a digital video playback system comprising an image device adapted to accept a coded video, the above described decoder for decoding the coded video, and an output decoder for outputting the decoded video.

These and other aspects of the invention will be apparent from and elucidated with reference to the embodiments described hereinafter.

### BRIEF DESCRIPTION OF THE DRAWINGS

The invention will now be described in greater detail with reference to the accompanying drawings in which:

FIG. 1 is a schematic representation of a transform based encoding scheme,

FIG. 2 is a schematic representation of a transform based decoding scheme,

FIG. 3 is an illustration of a non-zero coefficients bounding box within a data block,

FIG. 4 is an illustration of a method according to the present invention,

FIG. 5 is an exemplary system using the coding scheme of FIG. 1,

FIG. 6 is an exemplary system using the decoding scheme of FIG. 2,

FIG. 7 demonstrates the computation reduction available using the methods of the present invention, and

FIG. 8 demonstrates the computation reduction available using the methods of the present invention where a mismatch bit is included.

### DETAILED DESCRIPTION OF THE DRAWINGS

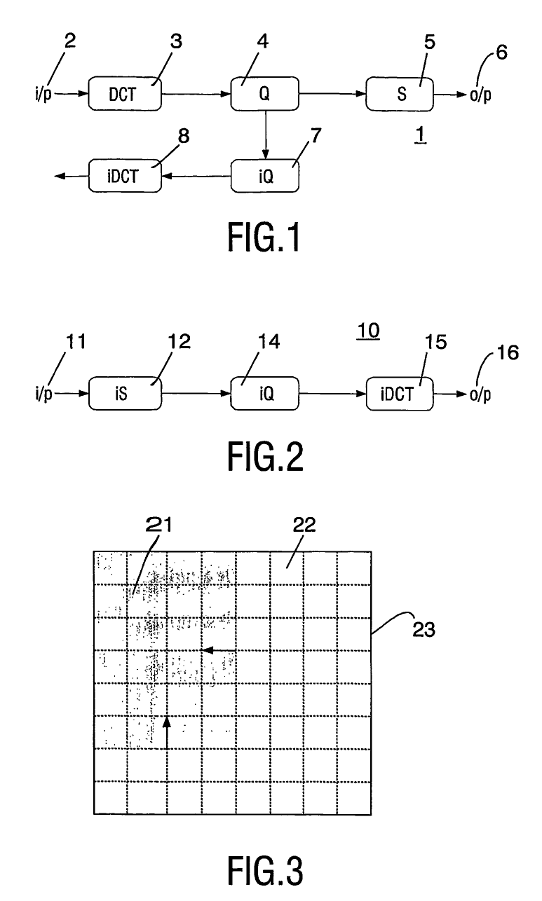

A transform based coder 1, as illustrated in FIG. 1, typically comprises a transform element 3, a quantising element 4, a scanning element 5, an inverse quantising element 7 and an inverse scanning element 8. The individual elements of the coder may be implemented in software and/or hardware either individually or in combined form. These types of coder may be found in digital video recording devices, for example digital video cameras.

The transform element 3, which in the exemplary coder shown is a Discrete Cosine Transform (DCT) based transform element, converts incoming blocks 2 of spatial coefficient data into corresponding blocks of frequency coefficient data, i.e. converts input data from the spatial to the frequency domain. The incoming blocks of spatial data may be provided as illustrated in FIG. 5 by an associated input device 40, for example a CCD array and associated circuitry of a digital video camera. After the digital video has been coded in the coder 1 it may be output to an appropriate output device 42, for example a magnetic or semiconductor memory. After conversion of input data from the spatial to the frequency domain, the DCT element 3 communicates the resulting blocks of frequency coefficient data to the quantising element 4. Each individual block of data is recognisable as a cartesian block or matrix having a row-column structure of data coefficients.

Human perception of noise in images is not uniform but instead is a function of spatial frequency. More noise is tolerated at higher frequencies. Coders make use of this by rendering lower frequencies more accurately than higher frequencies. This rendering is primarily performed by the quantising element 4, which applies different weighting values to the different frequency coefficients in the data blocks received from the DCT element 3. Lower frequency coefficients are given a greater importance and thus a greater weighting than higher frequency components. After the weightings have been applied, low-value coefficients may be truncated to zero. The resulting weighted frequency component data blocks are then communicated to the scanning element 5.

The resulting data blocks received by the scanning element typically have a significant number of zero value coefficients. More efficient transmission of data blocks from the coder can be achieved if substantially all of the non-zero coefficients are sent first, followed by a code indicating that the remainder of coefficients are all zero. The scanning element 5 increases the probability of achieving this result, by ordering coefficients in a descending order of magnitude probability. Thus, for example in a non-interlaced system, a 45 degree zigzag scan is believed to achieve the best result.

The quantised frequency data blocks from the quantising element 4 may also be communicated to an inverse quantising element 7, which applies weighting factors substantially the inverse of the weighting values applied in the quantiser 4. However, the resulting data blocks are unlikely to be exact replicas of the frequency data blocks presented to the quantiser 4 owing to rounding errors and the truncation of low value coefficients within the quantiser 4. The resulting data blocks from the inverse quantiser 7 are communicated to the inverse transform element 8, which in the example shown is an inverse DCT element, which converts data blocks from the frequency domain back into the spatial domain. Thus the inverse quantiser and inverse transform elements provide a reconstructed estimate of the original input data. This reconstructed estimate may be used for temporal coding purposes.

A corresponding decoder 10, for decoding data encoded by the above coder, as shown in FIG. 2, comprises an inverse scanning element 12, an inverse transform element 15 and an inverse quantising element 14. As with the coder, the individual elements may be implemented in software and/or hardware either individually or in combined form. These types of decoder may typically be found in digital video playback devices, for example within the playback section of a digital video camera.

The incoming blocks 11 of frequency coefficient data are processed by the inverse scanning element 12 to reverse the process of scanning previously described.

The resulting frequency data blocks from the inverse scanning element 12 are communicated to an inverse quantising element 14, which applies weighting factors substantially the inverse of the weighting values applied in the quantiser 4 of the coder. The resulting data blocks from the inverse quantiser are communicated to an inverse transform element 15, for example an inverse DCT element, which converts data blocks from the frequency domain back into the spatial domain. Thus the decoder provides a reconstructed estimate of the original image data from the coded data. This reconstructed estimate may then be output from the decoder 10 to an output device 52, as illustrated in FIG. 6. The output device may for example be a LCD display device. The decoder receives its input from an appropriate input device 50 which may be a memory reading device, for example a magnetic tape reader.

In principle, the granularity at which data is communicated between the depicted functional units is on a block basis (e.g. using a block size of 8×8 coefficients). Thus individual image frames are segmented into blocks with each individual block corresponding to a different region of the image frame. Once the image data has been segmented into blocks, it is transmitted in block form between the internal elements of the coders/encoders.

When a coefficient block (i.e. a block containing frequency domain data) is examined in more detail, it appears that in general only a part of the block is filled with non-zero coefficients. These non-zero coefficients have a ‘natural tendency’ to concentrate in the upper left corner of the block (i.e. low frequencies), as represented in the bounding box 21 of non-zero coefficients in a 8×8 block 23 depicted in FIG. 3. Furthermore, after quantisation (upon encoding) the area of the block which is covered by non-zero coefficients can only get (and will very likely be) even smaller, which is depicted by the arrows in FIG. 3. It will be appreciated that the actual size of the bounding box 21 of non-zero coefficients may vary from block to block.

As demonstrated by the large number of zero values 22 in FIG. 3, the communication between the various functional units has a substantial overhead in the form of a variable number of zero coefficients. In the present invention, the natural tendency of non-zero coefficients to concentrate within a particular area 21 of the data blocks is used to achieve a reduction in the communication workload between functional elements within coders and/or decoders. This reduction in communication workload is achieved by reducing the size of individual blocks of data to produce reduced size data blocks prior to the communication of the individual data blocks to the next functional element within an encoder/decoder.

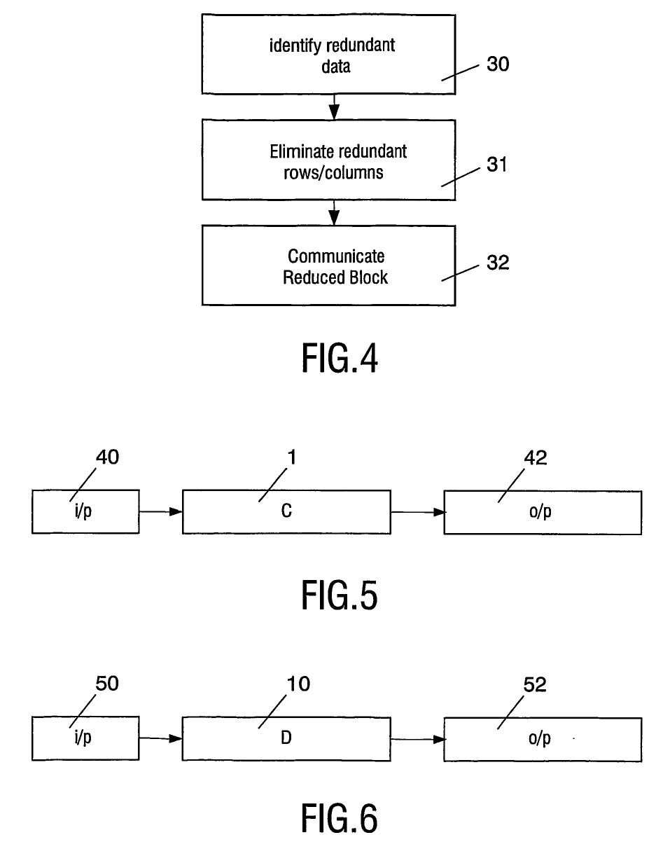

In a first exemplary embodiment, hereinafter referred to as the variable block size (VBS) method, of the invention, as illustrated in FIG. 4, the step of reducing the size of the at least one block of data in a first functional element comprises the initial step of identifying redundant rows and/or columns of the data block, i.e. rows or columns having only substantially zero valued coefficients. These determined redundant data (zero-valued) rows and/or columns may then be eliminated from the data block to produce a reduced size data block. Thus in the case of the exemplary 8×8 block illustrated in FIG. 3, the bottom two rows and the four columns to the right hand side would be eliminated as redundant data resulting in a reduced size data block 21 having four columns and six rows.

After a reduced size data block has been created, it may be communicated to a second functional element within the coder. As the amount of data being transferred is reduced the communication and associated computation workload is reduced. The data block reduction may be performed in one or more of the following functional elements within a coder; the transform element, the quantising element and/or the inverse quantising element.

Where data block reduction is performed in the transform element 3, the second (following) functional element is the quantising element 4. In the example where data block reduction is performed by the inverse quantiser 7, the second element is the inverse transform element 8 of the coder. In the case where data block reduction is performed in the quantising element 4, a reduced data block may be communicated to the scanning element 5 and/or the inverse quantising element 7, i.e. in this case the second element may comprise either the scanning element and/or the inverse scanning element.

In the exemplary method described above, only the coefficients within the bounding box of non-zero coefficients 21 are communicated between functional elements. It should be noted that the area of the bounding box may vary from data block to data block and accordingly the size of the reduced data blocks produced may vary from block to block.

In order to successfully process the coefficient data in a reduced data block, it may be necessary to communicate the dimensions of the reduced data block to the following functional unit.

A cost-effective implementation for identifying the redundant data of the above method uses a simple ‘OR’ operation over all the coefficients in both directions, and the subsequent determination of the value of the most significant bit of both results, gives the boundaries at the size of a power of 2 (1, 2, 4 or 8) and thus identifies which rows/columns are redundant. The dimensions of the boundary box, i.e. the number of columns and rows may be coded into two two-bit values for example using a look-up table. This implementation is very simple, but may lead to the communication of a column and/or rows containing only zero valued coefficients.

A more elaborate implementation, which gives an actual non-zero bounding box, may be implemented using comparative operations. In this case (for 8×8 blocks) the number of rows and columns may be transmitted to the following functional element using two three-bit values.

Although, the above described VBS method introduces some additional communication overhead in the form of the dimensions of the variable block, this is small compared to the reduction in communication workload. Furthermore, the reduction of communication and computation workloads, and the associated power savings, will vary depending on the data. On average, however a power reduction will be achieved. Additionally, the exemplary method as described up to here is lossless. The lossy part of the coding scheme, as in the non reduced block size methods of the prior art, substantially resides in the quantisation stage where the individual data coefficients are quantized.

A second exemplary embodiment of the present invention is now described which may add to the loss in the coder/decoder and thus reduce picture quality, but unlike the first embodiment the (reduced) communication and computation workloads will be predictable.

In this second exemplary embodiment, the dimensions of the reduced data blocks are predetermined. Thus the dimensions of the boundaries for the bounding box do not change from data block to data block. In this embodiment, the reduced data blocks are obtained by elimination of rows and columns of coefficients outside the boundary of the bounding box to remove redundant data. A disadvantage of this approach is that it may result in throwing away non-zero coefficients (non-redundant data) and thus an increase in loss or the unnecessary inclusion of rows/columns of zero value coefficients (redundant data). However, an advantage of this embodiment is that the dimensions of the bounding box do not have to be communicated between the individual functional elements, but may be known generally within the system. The boundary dimensions for the bounding box may be predetermined by using, for example, statistical analysis.

The above described methods may also be implemented within a decoder. In this case however, the reduction of block size and communication of the reduced size data blocks may be performed in either the inverse scanning element 12 or the inverse quantising element 14 of the decoder. Where the data block reduction is performed in the inverse scanning element 12, the second (following) functional element is the inverse quantising element 14. Where the data block reduction is performed in the inverse quantising element 14, the second (following) functional element is the inverse transform element 15.

The presently described methods may also be advantageous with respect to the internal computation workload within a functional element. This reduction in computation workload may be achieved using information concerning the dimensions of the bounding box of non-zero coefficients. In particular, computations involving the zero valued coefficients outside the reduced datablock received from a preceding functional unit may be eliminated or reduced within the receiving functional element. Especially for a software implementation, re-use of the already calculated information is quite advantageous.

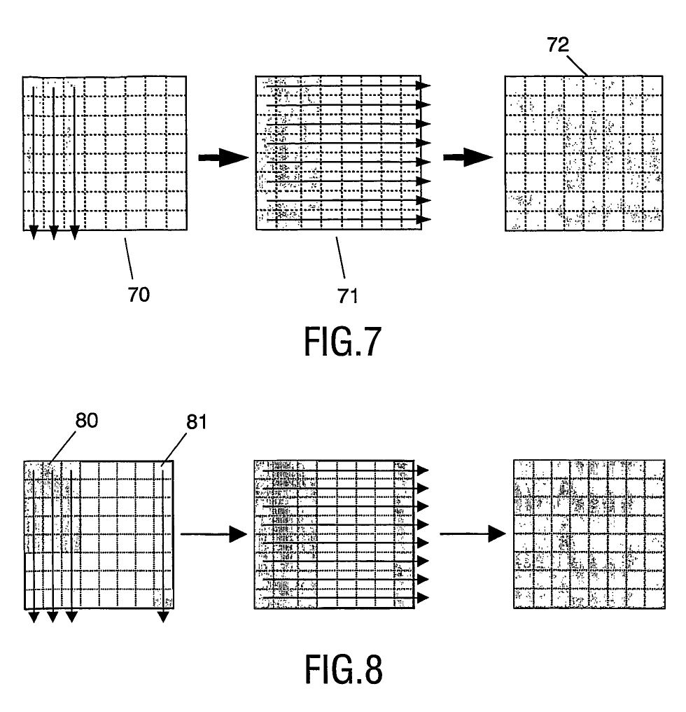

One possible exemplary method of reducing the computation work load will now be described. This exemplary method of reducing computation workload is suitable for use within the inverse transform element of an encoder or a decoder when performing inverse DCT (iDCT), in particular a two dimensional iDCT function may be decomposed by twice performing one dimensional iDCTs the results of which are illustrated in FIG. 7, for example by first performing 1D iDCT 70 on the columns of a data block, which results in a data block 71 in which the dimensions of the columns are extended to the full length of a normal data block and then performing a 1D iDCT on each of the rows to obtain a full sized data block 72. The alternative also applies, i.e. performing a first 1D iDCT on the rows of a block and then performing a 1D iDCT on the columns.

When using the reduced block size method of the present invention, 1D iDCT can be performed in one direction (i.e. either along the columns or rows) the same number of times as the smallest of the two dimensions of the variable block, followed by (for a standard block size of 8×8) eight times iDCT in the other direction.

Within the functional units like (inverse) quantisation and scan the VBS method has the advantage of not having to evaluate and/or calculate the zero coefficients which are not communicated.

On the other hand, the dimensions of the bounding box of the non-zero coefficients has to be calculated when the VBS method is applied. Within a decoding scheme this can easily be incorporated in the inverse scan algorithm, while after inverse quantisation the bounding box remains the same. Within an encoder scheme, the bounding box may be calculated (elimination of redundant rows/columns) after performing DCT. After quantisation the bounding box may become smaller, and accordingly the size of the bounding box can be further adjusted, i.e. further redundant data may be eliminated.

Experimental results have shown that savings of over 30% can be achieved in communication workloads using the methods of the present invention.

Experimental results have also shown a saving of about 14% in computation workload is achieved upon performing 1D iDCT first on columns, and about 11% where the 1D iDCCT is performed first on rows. This may be explained by keeping in mind the ‘natural’ dimensions of the bounding box of non-zero coefficients, i.e. the vertical dimension will on average be larger than the horizontal one. Thus, performing 1D iDCT first on columns will generally result in a lower computation workload.

It is known that the reconstructions of two differently implemented decoding stages may begin to diverge over time since their respective iDCT designs will occasionally reconstruct slightly different blocks. Within the MPEG standards the drift between different iDCT algorithms is reduced by means of so called ‘mismatch control’. Mismatch control eliminates bit patterns, which statistically have the greatest contribution towards mismatches between the variety of methods.

Mismatch control may be implemented in several ways. The MPEG-2 standard adopted a method referred to as ‘LSB toggling’, which reduces the likelihood of mismatch between decoders. LSB toggling only affects the least significant bit (LSB) of the 63rd AC DCT (F[7][7]) coefficient (the highest frequency in the DCT matrix) after inverse quantization. The toggling operation is set out mathematically below, but in summary all of the reconstructed coefficients (F′[v][u]) in a block are summed and if the sum of all of the reconstructed coefficients is even then the LSB of coefficient F[7][7] is toggled either by addition or subtraction of a bit depending on whether the reconstructed 63rd AC DCT (F′[7][7]) value is even or odd.

$$sum = {\sum }_{v = 0}^{v < 8} {\sum }_{u = 0}^{u < 8} {F}^{′} [ v ] [ u ] , \\ F [ v ] [ u ] = {F}^{′} [ v ] [ u ] for all u , v expected u = v = 7 , \\ F [ 7 ] [ 7 ] = \{ \begin{matrix}{F}^{′} [ 7 ] [ 7 ] & if sum is odd \\ \{ \begin{matrix}{F}^{′} [ 7 ] [ 7 ] - 1 if {F}^{′} [ 7 ] [ 7 ] is odd \\ {F}^{′} [ 7 ] [ 7 ] + 1 if {F}^{′} [ 7 ] [ 7 ] is even\end{matrix} \} & if sum is even\end{matrix}$$

As a consequence of the mismatch control within the decoding stage, the highest frequency coefficient within a block is quite often equal to 1, while a large area of the block is filled with zeros. This would still lead to the communication of the whole 8×8 block when the VBS method described above is applied. However, this may be prevented in a number of different ways, including for example the following:
1. Performing mismatch control within the iDCT element. By performing mismatch control within the iDCT element (either before, during or after iDCT calculations) and not at the end of inverse quantization full advantage may be obtained from the reduced block sizes.
2. Communicating a mismatch control bit for a data block from the inverse quantization element to the iDCT element. This option has the advantage of saving computation workload compared to the first method, because the sum of the DCT coefficients are easily calculated during inverse quantization processes. The communicated mismatch control bit may be subsequently used to ensure mismatch control.
3. Not performing mismatch control. As mismatch control has only a small visual influence on the resulting data, it is suggested that the step may be omitted altogether.

The results of experiments conducted in order to see what the influence is of not performing mismatch control in an MPEG-2 decoder, have shown that the resulting data from a decoder is substantially identical regardless of whether mismatch control is performed or not. However, the computational workload where mismatch control is performed in the quantising stage achieves approximately only half of the computational workload reductions achieved by the same methods omitting mismatch control from the quantising stage. As expected, not performing mismatch control has a tremendous influence on the communication workload.

When mismatch control is performed in the iDCT stage, the influence on computation workload depends on the chosen way to do mismatch control. When mismatch control is not done at all or after iDCT the computation workload is strongly reduced (to about the same extent as the communication workload). When it is done before performing iDCT the computation workload for performing 2 times 1D iDCT stays the same, except when iDCT on the 8th column 81 or row is regarded separately from the iDCT over the other non-zero columns 80 or rows, as illustrated in FIG. 8. In this way a possible 1 extra 1D iDCT (if the ‘mismatch control bit’ is set) may have to be performed.

However, it will be appreciated, that it may not be necessary to perform the vertical iDCT for the 8th column as the resulting value is a known constant vector, which is non zero for all of its eight elements. So the iDCT operation may be performed by the addition of the constant vector into the (last) arguments of the subsequent horizontal iDCTs.

Note that the schemes presented in this document are functional diagrams, and do not imply any implementation of an architecture. In an actual hardware implementation, the functions can be divided over hardware elements (e.g. co-processors) or combined into single hardware elements.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A method of communicating at least one block of data from a first functional element within a transform based coder or decoder to a second functional element within the coder or decoder, wherein the at least one block of data comprises a row-column structure of data coefficients, characterized in that the method comprises the steps of: reducing the size of the at least one block of data to produce a reduced size data block by elimination of one or more rows and/or columns of redundant data coefficients, and communicating the reduced size data block from the first functional element to the second functional element.

2. A method of communicating at least one block of data according to claim 1, wherein the step of reducing the size of the at least one block of data may comprise the steps of identifying rows and/or columns having only substantially zero valued coefficients as redundant data.

3. A method according to claim 2, where the dimensions of the reduced size data block are communicated to the second functional element.

4. A method according to claim 1, wherein the step of reducing the size of the at least one block of data is achieved by the elimination of coefficients outside a predetermined boundary.

5. A transform based coder or decoder element adapted to communicate at least one block of data, comprising a row-column structure of data coefficients, to a second functional element of the coder or decoder, comprising means for reducing the size of the at least one block of data to produce a reduced size data block by elimination of one or more rows and/or columns of substantially zero valued coefficients, and means for communicating the reduced size data block to the second functional element.

6. A transform based coder or decoder element according to claim 5, wherein the means for reducing the size of the at least one block of data is implemented by selection of coefficients within a predetermined boundary.

7. A transform based coder or decoder element according to claim 5, wherein the means for reducing the size of the at least one block of data is adapted to identify rows and/or columns having only substantially zero valued coefficients as redundant data.

8. A transform based coder or decoder element according to claim 7, wherein the element is adapted to communicate the dimensions of the reduced size data block to the second element.

9. A digital video recording system comprising an input device for acquiring a video image,
a transform based coder according to claim 5 for coding the acquired video image, and
an output device for outputting the acquired coded image.

10. A digital video playback system comprising an image device adapted to accept a coded video image,
a decoder according to claim 5 for decoding the coded video, and
an output device for outputting the decoded video.
